(19) United States
(12) Patent Application Publication
(10) Pub. No.: US 2017/0066620 A1
(43) Pub. Date: Mar. 9, 2017

(54) IMAGE FORMING SYSTEM CAPABLE OF COPING WITH SHIFTED SADDLE-STITCHING OR CENTER-FOLDING POSITION

(71) Applicant: CANON KABUSHIKI KAISHA, Tokyo (JP)

(72) Inventors: Akihiro Arai, Toride-shi (JP); Yutaka Ando, Toride-shi (JP); Akinobu Nishikata, Abiko-shi (JP); Hiromasa Maenishi, Matsudo-shi (JP)

(21) Appl. No.: 15/252,682

(22) Filed: Aug. 31, 2016

(30) Foreign Application Priority Data
Sep. 9, 2015 (JP) 2015-177544

(51) Int. Cl. B65H 43/00; G03G 15/00; B65H 37/06; B65H 35/00; B65H 37/04

(52) U.S. Cl. CPC B65H 43/00; B65H 35/0006; B65H 37/04; B65H 37/06; G03G 15/6582; B65H 2301/5152; B65H 2301/452; B65H 2301/51611

(57) ABSTRACT

An image forming system capable of producing a center-folded or saddle-stitched brochure having punched holes at identical positions between the front and back sides thereof even when a saddle-stitching or center-folding position is set to a location shifted from a sheet center position. A puncher punches holes in a sheet. A finisher folds a sheet bundle formed by sheets each having the holes punched therein. A console sets an adjustment value for adjusting a folding position at which the sheet bundle is folded by the finisher, according to a manual operation. When the adjustment value is larger than a reference value, the puncher determines a punching position with respect to a folding position having the adjustment value reflected thereon and punches the holes in the determined punching position.

### BACKGROUND OF THE INVENTION

Field of the Invention

The present invention relates to an image forming system including a punching unit and a center-folding unit, which is capable of coping with a shifted saddle-stitching or center-folding position to produce a center-folded or saddle-stitched brochure.

Description of the Related Art

Conventionally, there has been proposed a puncher for punching holes in a sheet at locations symmetrical with respect to the center of the sheet length of the sheet in a sheet conveying direction before execution of saddle stitching, so as to bind a saddle-switched sheet bundle, for example, in a binder (see Japanese Patent Laid-Open Publication No. 2000-1256).

Further, there has been proposed an image forming system provided with a folding position adjustment function for adjusting a folding position of a sheet bundle to be bookbound, in sheet processing for saddle-stitch bookbinding so as to correct deviation of the folding position e.g. due to the type of sheets or the number of sheets of the bundle (see e.g. Japanese Patent Laid-Open Publication No. 2009-132485).

Generally, in the case of punching holes in each of sheets to be center-folded, so as to bind the sheets e.g. in a binder, the holes are punched in each sheet at locations symmetrical with respect to the center of the sheet length of the sheet in the sheet conveying direction, as described in Japanese Patent Laid-Open Publication No. 2000-1256.

However, in a case where a sheet bundle is subjected to saddle-stitch bookbinding, position adjustment is sometimes performed by a user such that a saddle-stitching or center-folding position is intentionally shifted. In this case, if holes are punched in a sheet at the locations symmetrical with respect to the center of the sheet length of the sheet in the sheet conveying direction as described in Japanese Patent Laid-Open Publication No. 2000-1256, a saddle-stitched brochure cannot have the punched holes at respective locations symmetrical with respect to the shifted center-folding position. In such a case, it is impossible to obtain a brochure having punched holes as intended by the user for binding the brochure in a binder.

### SUMMARY OF THE INVENTION

The present invention provides an image forming system which, even when a saddle-stitching or center-folding position is set to a location shifted from a sheet center position, is capable of coping with a shifted saddle-stitching or center-folding position, to thereby produce a center-folded or saddle-stitched brochure having punched holes at identical positions between the front and back sides thereof.

In a first aspect of the invention, there is provided a image forming system comprising a punching unit configured to punch holes in a sheet, a folding unit configured to fold a sheet bundle formed by sheets each having the holes punched therein, and a setting unit configured to set an adjustment value for adjusting a folding position where the folding unit folds the sheet bundle, according to a manual operation, wherein when the adjustment value set by the setting unit is larger than a reference value, the punching unit determines a punching position with respect to a folding position on which is reflected the adjustment value set by the setting unit, and punches the holes at the determined punching position.

In a second aspect of the invention, there is provided an image forming system comprising a punching unit configured to punch holes in a sheet, a folding unit configured to fold a sheet bundle formed by sheets each having the holes punched therein, and a setting unit configured to set a shift amount for shifting a folding position from a center of a sheet length of the sheet in a sheet conveying direction, according to a manual operation, wherein when the shift amount is set by the setting unit, the punching unit determines a punching position with respect to a folding position on which the shift amount is reflected, and punches the holes in the determined punching position.

According to the invention, when the folding position is set to a location shifted from the center of the sheet length, the punching positions are changed to respective locations symmetrical with respect to the shifted folding position, to thereby cope with the shifted saddle-stitching or center-folding position. This makes it possible to produce a center-folded or saddle-stitched brochure having punched holes at identical positions between the front and back sides thereof, without requiring any troublesome operation.

Further features of the present invention will become apparent from the following description of exemplary embodiments (with reference to the attached drawings).

### BRIEF DESCRIPTION OF THE DRAWINGS

FIG. 1 is a schematic cross-sectional view of an image forming system according to an embodiment of the present invention.

FIG. 2 is a control block diagram of the image forming system shown in FIG. 1.

FIG. 3 is a block diagram of a puncher controller appearing in FIG. 2.

FIG. 4 is a block diagram of a finisher controller appearing in FIG. 2.

FIG. 5 is a flowchart of a punching process performed as a part of a bookbinding process by the image forming system shown in FIG. 1.

FIG. 6 is a view of a console.

FIGS. 7A to 7E are views of configuration screens, which are displayed on the console, for setting a folding position adjustment value.

FIGS. 8A to 8C are views of configuration screens, which are displayed on the console, for setting a punching mode.

FIGS. 9A to 9F are views useful in explaining a punching conveyance distance and punching.

FIG. 10 is a flowchart of a sheet bundle-forming process performed by the image forming system shown in FIG. 1.

FIGS. 11A to 11C are views useful in explaining a stapling position of a positioning member on a brochure tray.

FIGS. 12A to 12E are views illustrating a procedure of center-folding performed on the brochure tray.

FIG. 13 is a flowchart of a second punching process performed as a part of the bookbinding process by the image forming system shown in FIG. 1.

FIGS. 14A to 14E are views of configuration screens, which are displayed on the console, for setting a shifted-folding position adjustment value.

FIG. 15 is a second sheet bundle-forming process performed by the image forming system shown in FIG. 1.

### DESCRIPTION OF THE EMBODIMENTS

The present invention will now be described in detail below with reference to the accompanying drawings showing embodiments thereof.

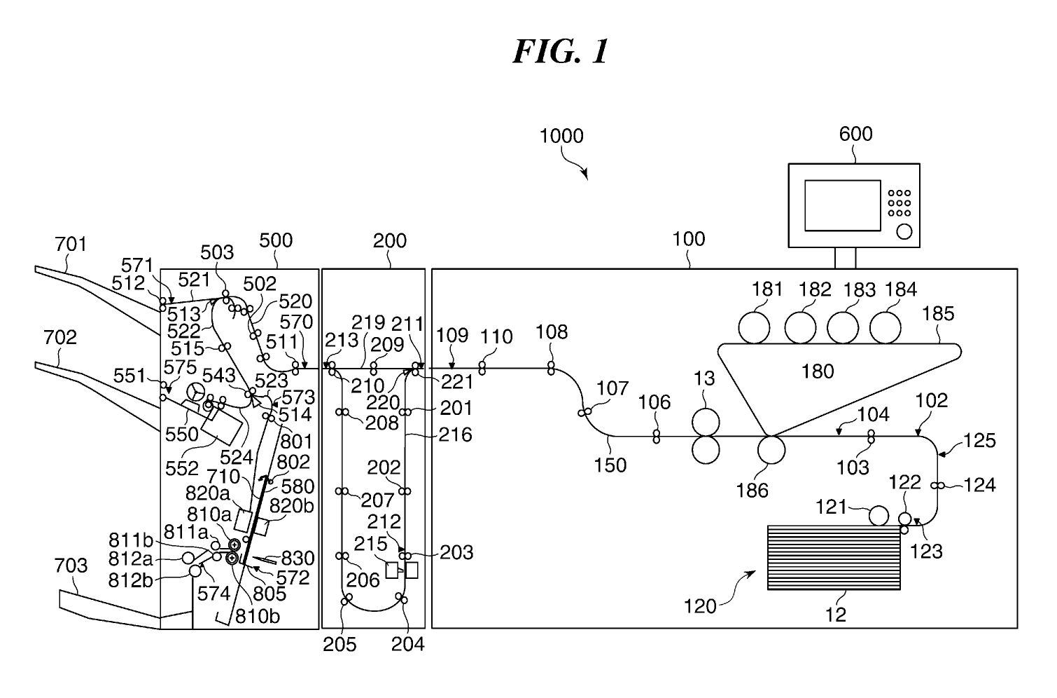

FIG. 1 is a schematic cross-sectional view of an image forming system according to an embodiment.

As shown in FIG. 1, the image forming system 1000 is comprised of an image forming apparatus 100, a puncher 200, a sheet processing apparatus (finisher) 500, and a console 600.

The image forming apparatus 100 includes an image forming section 180 for forming images, a sheet feeding section 120 for storing sheets, and a conveyance passage 150 for conveying a sheet P stored in the sheet feeding section 120 to a downstream apparatus via the image forming section 180.

The image forming section 180 is comprised, for example, of a plurality of photosensitive drums 181 to 184 arranged side by side in a horizontal direction, an intermediate transfer member 185 disposed below the photosensitive drums 181 to 184, and a secondary transfer roller 186 for transferring an image transferred on the intermediate transfer member 185 onto a sheet P. The sheet feeding section 120 includes a sheet feed cassette 12 and a pickup roller 121 provided above the sheet feed cassette 12. On the conveyance passage 150, there are provided a separation roller pair 122 disposed at an outlet of the sheet feed cassette 12, and a sheet feed sensor 123, a vertical path roller pair 124, a vertical path sensor 125, a pre-registration sensor 102, a registration roller pair 103, and a registration sensor 104, which are sequentially arranged downstream of the separation roller pair 122. Further, on the conveyance passage 150, there are provided a fixing section 13 disposed downstream of the secondary transfer roller 186, conveying roller pairs 106, 107, and 108 sequentially arranged downstream of the fixing section 13, a discharge roller pair 110, and a sheet discharge sensor 109.

In the image forming apparatus 100 configured as above, sheets P are fed one by one from the sheet feed cassette 12 containing the sheets P. More specifically, the sheets P stacked in the sheet feed cassette 12 are lifted up to a position where a top sheet P is brought into contact with the pickup roller 121, by operations of a lifter motor and a sheet surface sensor, neither of which are shown. The pickup roller 121 conveys the top sheet P to the separation roller pair 122. The separation roller pair 122 includes an upper roller rotating in a feed direction and a lower roller rotating in a return direction, and the respective rotations of the upper and lower rollers separate one sheet after another from the sheets P, thereby causing each sheet P to be sent toward the secondary transfer roller 186.

At this time, the sheet feed sensor 123 checks whether or not a sheet P has been picked up and conveyed in predetermined timing, and if the sheet feed sensor 123 does not detect a sheet P even when a predetermined time period has elapsed after the start of the pick-up operation, it is determined that a sheet feeding jam has occurred.

A sheet P separated by the separation roller pair 122 is conveyed into a vertical path of the conveyance passage 150 and then guided by the vertical path roller pair 124 provided on the vertical path into a horizontal path via the vertical path sensor 125. The secondary transfer roller 186 provided on the horizontal path transfers, onto the sheet P, an image having been formed in the image forming section 180 and transferred onto the intermediate transfer member 185. At this time, registration between the image in the image forming section 180 and the leading edge of the sheet P conveyed into the horizontal path is performed using the pre-registration sensor 102, the registration roller pair 103, and the registration sensor 104.

The sheet P having the image transferred thereon is conveyed to the fixing section 13, and is pressed and heated. This causes the image transferred on the sheet P to be fixed on the same. Then, the sheet P having the image fixed thereon is conveyed to the discharge roller pair 110 by the conveying roller pairs 106, 107, and 108, and is discharged by the discharge roller pair 110 into the puncher 200 as a downstream apparatus. At this time, the sheet discharge sensor 109 checks whether or not the discharge of the sheet P has been completed in predetermined timing, and if the sheet P is not discharged even after the lapse of a predetermined time period, it is determined that a jam has occurred.

Next, a description will be given of the configuration of the puncher 200.

As shown in FIG. 1, the puncher 200 has a straight conveying path 219 for conveying a received sheet P without performing punching on the same and a U-shaped punching path 216 into which a sheet P to be subjected to punching is conveyed. On the conveying path 219, there are arranged conveying roller pairs 221, 209, and 210 along a sheet conveying direction in the mentioned order, and a conveyance sensor 211 is disposed upstream of the conveying roller pair 221. Further, a conveyance sensor 213 is disposed downstream of the conveying roller pair 210. The U-shaped punching path 216 has an inlet thereof connected to the conveying path 219 at a location downstream of the conveying roller pair 221, and an outlet thereof connected to the conveying path 219 at a location upstream of the conveying roller pair 210.

At a bifurcation where the punching path 216 branches from the conveying path 219, there is provided a switching flapper 220. Further, on the punching path 216, there are arranged conveying roller pairs 201, 202, and 203, a punching unit 215, and conveying roller pairs 204, 205, 206, 207, and 208 along a sheet conveying direction in the mentioned order. At a location upstream of the punching unit 215, there is disposed a conveyance sensor 212.

The puncher 200 configured as above sequentially takes in sheets P discharged from the image forming apparatus 100 and performs punching on the taken-in sheets P, as required, so as to punch holes in each of the sheets P. Whether or not to perform punching is determined based on sheet information sent from the image forming apparatus 100. The sheet information will be described in detail hereinafter.

When punching is not to be performed on a sheet P discharged from the image forming apparatus 100, the sheet P is guided into the conveying path 219 via the conveying roller pair 221 and the switching flapper 220, and is conveyed to the finisher 500 as a downstream apparatus by the conveying roller pairs 209 and 210.

On the other hand, when punching is to be performed on a sheet P discharged from the image forming apparatus 100, the sheet P is guided into the punching path 216 via the conveying roller pair 221 and the switching flapper 220, and is conveyed into the punching unit 215 via the conveying roller pairs 201, 202, and 203. The punching unit 215 performs punching on the sheet P conveyed therein, whereby holes are punched in the sheet P at respective predetermined locations. The sheet P subjected to punching is discharged into the finisher 500 located downstream via the conveying roller pairs 204, 205, 206, 207, 208, and 210.

During the above-described process, the conveyance sensor 211 detects the sheet P to be conveyed into the puncher 200, and the conveyance sensor 212 detects the sheet P to be conveyed into the punching unit 215. Further, the conveyance sensor 213 detects the sheet P to be conveyed into the finisher 500.

Next, a description will be given of the configuration of the finisher 500.

As shown in FIG. 1, the finisher 500 has a conveying path 520 for receiving a sheet P discharged from the puncher 200 and an upper discharge path (non-sorting path) 521 for conveying a received sheet P to a sample tray 701 which is an upper tray. Further, the finisher 500 has an intermediate discharge path (sorting path) 522 for conveying a sheet P to a stacking tray 702 which is an intermediate tray, and a bookbinding path 523 for conveying a sheet P to a brochure tray 703 which is a lower tray.

On the conveying path 520, there are arranged an inlet sensor 570, an inlet roller pair 511, and conveying roller pairs 502 and 503 along the conveying direction of a sheet P. The conveying path 520 is bifurcated into the non-sorting path 521 and the sorting path 522 at a location downstream of the conveying roller pair 503. At a bifurcation into the non-sorting path 521 and the sorting path 522, there is provided a switching flapper 513. On the non-sorting path 521 extending from the switching flapper 513 to the sample tray 701, there are disposed a sheet discharge sensor 571 and a sheet discharge roller pair 512.

The sorting path 522 is provided with conveying roller pairs 515 and 543, and is bifurcated into a processing path 524 and the bookbinding path 523 at a location downstream of the conveying roller pair 543. At a bifurcation into the processing path 524 and the bookbinding path 523, there is provided a switching flapper 514. On the processing path 524, there are arranged a processing tray 550, a stapler 552, a sheet discharge sensor 575, and a bundle discharge roller pair 551. The stapler 552 is movable along the outer periphery of the processing tray 550, and performs stitching on the trailing end of sheets stacked as a bundle on the processing tray 550.

On the bookbinding path 523, there are provided a bookbinding inlet sensor 573 and a conveying roller pair 801. The bookbinding path 523 extends to the brochure tray 703 via a bookbinding tray 580.

The bookbinding tray 580 is provided with a movable positioning member 805 for positioning a sheet P by abutment with the leading edge of the sheet P in the sheet conveying direction, and a sheet holding member 802 for fixedly holding the trailing edge of the sheet P. Further, the bookbinding tray 580 is provided with a saddle-stitching stapler 820a and an anvil 820b for performing stitching on a sheet bundle 710 of stacked sheets P. Furthermore, the bookbinding tray 580 is provided with a pair of folding rollers 810a and 810b for folding the sheet bundle 710, a thrusting member 830 disposed at a location opposed to the folding rollers 810a and 810b, and a pair of folding conveying rollers 811a and 811b for conveying the folded sheet bundle 710. At a location downstream of the folding conveying rollers 811a and 811b, there is provided a sheet discharge sensor 574, and at a location downstream of the sheet discharge sensor 574, there are provided a pair of folding discharge rollers 812a and 812b.

The finisher 500 configured as above sequentially takes in sheets P discharged from the puncher 200, and performs bundling for aligning the taken-in sheets P into a bundle and stapling (stitching) for stitching the trailing end of the sheet bundle with staples. Further, the finisher 500 performs various post-processing, such as punching for punching holes, sorting, non-sorting, and bookbinding, on the taken-in sheets P.

More specifically, the finisher 500 takes in a sheet P discharged from the puncher 200 to the conveying path 520, by the inlet roller pair 511, and conveys the taken-in sheet P by the conveying roller pairs 502 and 503.

When a sheet P is to be guided into the non-sorting path 521, the position of the switching flapper 513 is switched so as to convey the sheet P toward the sample tray 701. The sheet P conveyed into the non-sorting path 521 is discharged onto the sample tray 701 via the sheet discharge roller pair 512. At this time, the sheet discharge sensor 571 detects the sheet P to be discharged onto the sample tray 701.

When a sheet P is to be guided into the sorting path 522, the position of the switching flapper 513 is switched so as to cause the sheet P to be conveyed into the sorting path 522. The sheet P conveyed into the sorting path 522 is stacked on the processing tray 550 via the conveying roller pair 515 and the switching flapper 514. Sheets P stacked as a bundle on the processing tray 550 are subjected, as required, to alignment processing by an alignment member, not shown, and stapling or the like, and then the processed sheets P are discharged onto the stacking tray 702 by the bundle discharge roller pair 551. At this time, the sheet discharge sensor 575 detects the sheets P to be discharged onto the stacking tray 702.

When a sheet P is to be conveyed into the bookbinding path 523, the position of the switching flapper 514 is switched so as to cause the sheet P to be conveyed into the bookbinding path 523. The sheet P conveyed into the bookbinding path 523 is conveyed onto the bookbinding tray 580 by the conveying roller pair 801. At this time, the bookbinding inlet sensor 573 detects the sheet P to be conveyed onto the bookbinding tray 580.

Sheets P conveyed onto the bookbinding tray 580 are aligned into the sheet bundle 710. The saddle-stitching stapler 820a and the anvil 820b cooperate with each other to perform stapling on the sheet bundle 710, as required. After completion of stapling, the movable positioning member 805 is moved by a predetermined distance, whereby a stapling position of the sheet bundle is brought to a position opposed to the thrusting member 830. Then, the thrusting member 830 is thrust toward the sheet bundle 710 to thereby push the sheet bundle 710 on the bookbinding tray 580 in between the folding rollers 810a and 810b, whereby the folding rollers 810a and 810b cause the sheet bundle 710 to be folded in two.

The folding rollers 810a and 810b thus fold the sheet bundle, and also convey the folded sheet bundle downstream. The sheet bundle conveyed by the folding rollers 810a and 810b and the folding conveying rollers 811a and 811b is discharged and stacked onto the brochure tray 703 by the downstream discharge rollers 812a and 812b. At this time, the sheet discharge sensor 574 detects the sheet bundle to be discharged onto the brochure tray 703.

Next, a description will be given of the control configuration of the image forming system shown in FIG. 1.

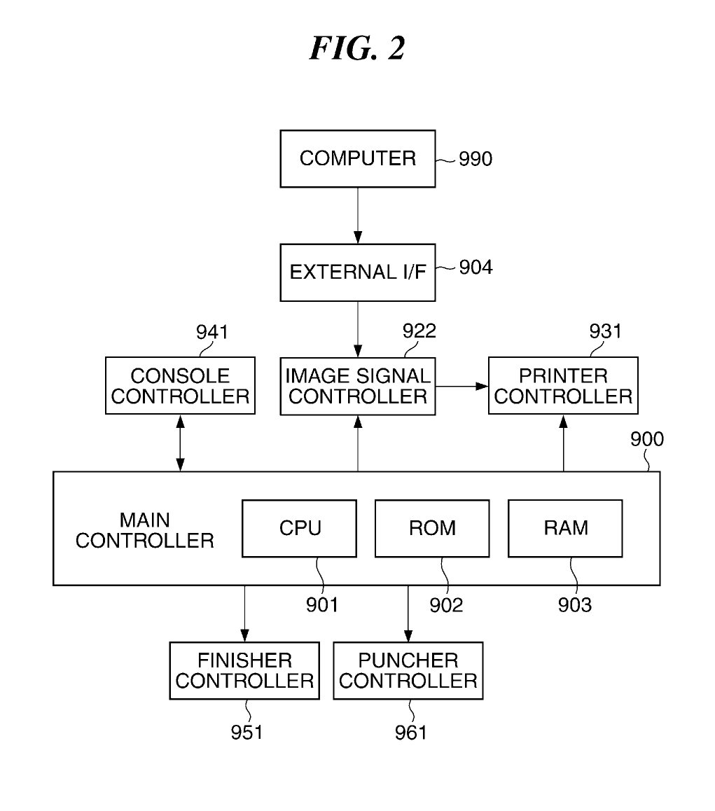

FIG. 2 is a control block diagram of the image forming system.

Referring to FIG. 2, the image forming system 1000 has a main controller 900. The main controller 900 includes a CPU 901, a ROM 902, and a RAM 903. The CPU 901 is connected by an address bus or a data bus to the ROM 902 having control programs written therein and the RAM 903 for temporarily storing data to perform processing.

The CPU 901 is connected to each of various controllers 922, 904, 931, 941, 951, and 961, referred to hereafter, and performs centralized control of these according to control programs stored in the ROM 902. The various controllers mentioned above include an image signal controller 922, an external interface 904, a printer controller 931, a console controller 941, a finisher controller 951, and a puncher controller 961. The RAM 903 temporarily holds control data, and is also used as a work area for arithmetic operations involved in control processing.

The image signal controller 922 performs various processing on a digital image signal input from a computer 990 via the external interface 904, converts the digital image signal to a video signal, and outputs the video signal to the printer controller 931. The processing operations by the image signal controller 922 are controlled by the main controller 900. The printer controller 931 controls an exposure section, not shown, and the image forming apparatus 100, based on the input video signal, to perform image formation and sheet conveyance.

The puncher controller 961 is mounted in the puncher 200 and controls driving of the whole puncher 200 by exchanging information with the main controller 900. Details of this control operation will be described hereinafter.

The finisher controller 951 is mounted in the finisher 500, and controls driving of the whole finisher 500 by exchanging information with the main controller 900. Details of this control operation will be described hereinafter.

The console controller 941 exchanges information with the console 600 and the main controller 900. The console 600 has a plurality of keys for configuring various functions concerning image formation, a display section that displays information indicating a configuration state, and so forth. Further, the console 600 outputs a key signal corresponding to an operation of each key to the main controller 900, and displays corresponding information based on a signal from the main controller 900.

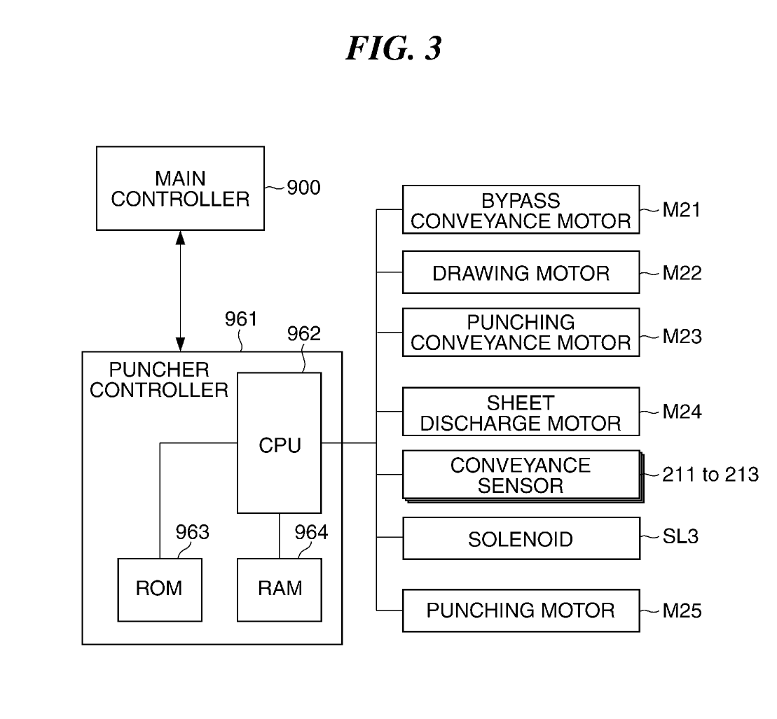

Next, a description will be given of the control configuration of the puncher 200. FIG. 3 is a block diagram of the puncher controller 961.

Referring to FIG. 3, the puncher controller 961 includes a CPU 962, a ROM 963, and a RAM 964. The CPU 962 is connected to each of a bypass conveyance motor M21, a drawing motor M22, a punching conveyance motor M23, a sheet discharge motor M24, the conveyance sensors 211 to 213, a solenoid SL3, and a punching motor M25.

The puncher controller 961 communicates with the main controller 900 of the image forming apparatus 100 via a communication IC, not shown, to exchange data including job information and a sheet receipt or delivery notification. The CPU 962 of the puncher controller 961 executes various programs stored in the ROM 963 according to instructions from the main controller 900, to thereby control the driving of the puncher 200.

The bypass conveyance motor M21, the drawing motor M22, the punching conveyance motor M23, and the sheet discharge motor M24 drive the conveying roller pairs 201 to 210 and 221 for sheet conveyance. The punching motor M25 causes the punching unit 215 to operate such that punching is performed on a sheet P. The solenoid SL3 drives the switching flapper 220. Each of the conveyance sensors 211 to 213 detects passage of a sheet on the conveying path 219 or the punching path 216.

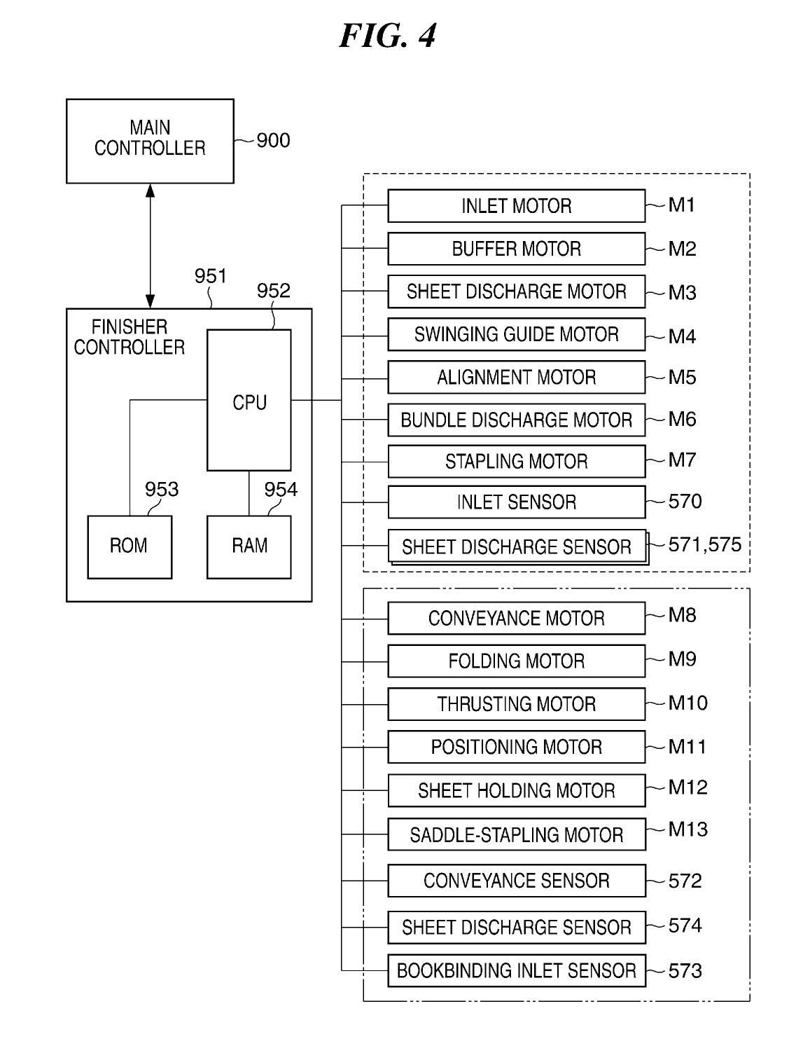

Next, a description will be given of the control configuration of the finisher 500. FIG. 4 is a block diagram of the finisher controller 951 appearing in FIG. 2.

Referring to FIG. 4, the finisher controller 951 includes a CPU 952, a ROM 953, and a RAM 954. The CPU 952 is connected to each of an inlet motor M1, a buffer motor M2, a sheet discharge motor M3, a swinging guide motor M4, an alignment motor M5, a bundle discharge motor M6, a stapling motor M7, the inlet sensor 570, and the sheet discharge sensors 571 and 575. Further, the CPU 952 is connected to each of a conveyance motor M8, a folding motor M9, a thrusting motor M10, a positioning motor M11, a sheet holding motor M12, a saddle-stapling motor M13, the bookbinding inlet sensor 573, the conveyance sensor 572, and the sheet discharge sensor 574.

The finisher controller 951 communicates with the main controller 900 of the image forming apparatus 100 via the communication IC, not shown, to exchange data. The CPU 952 of the finisher controller 951 executes various programs stored in the ROM 953 according to instructions from the main controller 900, to thereby control the driving of the finisher 500.

The inlet motor M1 drives the inlet roller pair 511 and the conveying roller pair 502. The buffer motor M2 drives the conveying roller pair 503. The sheet discharge motor M3 drives the sheet discharge roller pair 512 and the conveying roller pair 515. The swinging guide motor M4 lifts up and down a swinging guide, not shown. The alignment motor M5 drives the alignment member, not shown.

The bundle discharge motor M6 as means for driving various members of the processing tray 550 drives the bundle discharge roller pair 551. The stapling motor M7 drives the stapler 552. Each of the inlet sensor 570 and the sheet discharge sensors 571 and 575 detects passage of a sheet.

The conveyance motor M8 drives the conveying roller pair 801 provided on the bookbinding path 523. The folding motor M9 drives the folding rollers 810a and 810b. The thrusting motor M10 drives the thrusting member 830. The positioning motor M11 lifts up and down the positioning member 805. The sheet holding motor M12 drives the sheet holding member 802. The saddle-stapling motor M13 drives the saddle-stitching stapler (saddle stapler) 820a. Each of the bookbinding inlet sensor 573, the conveyance sensor 572, and the sheet discharge sensor 574 detects passage of a sheet.

Next, a description will be given of a punching process performed as a part of the bookbinding process by the image forming system shown in FIG. 1. This punching process is performed by the CPU 962 of the puncher 200 according to a punching process program stored in the ROM 963.

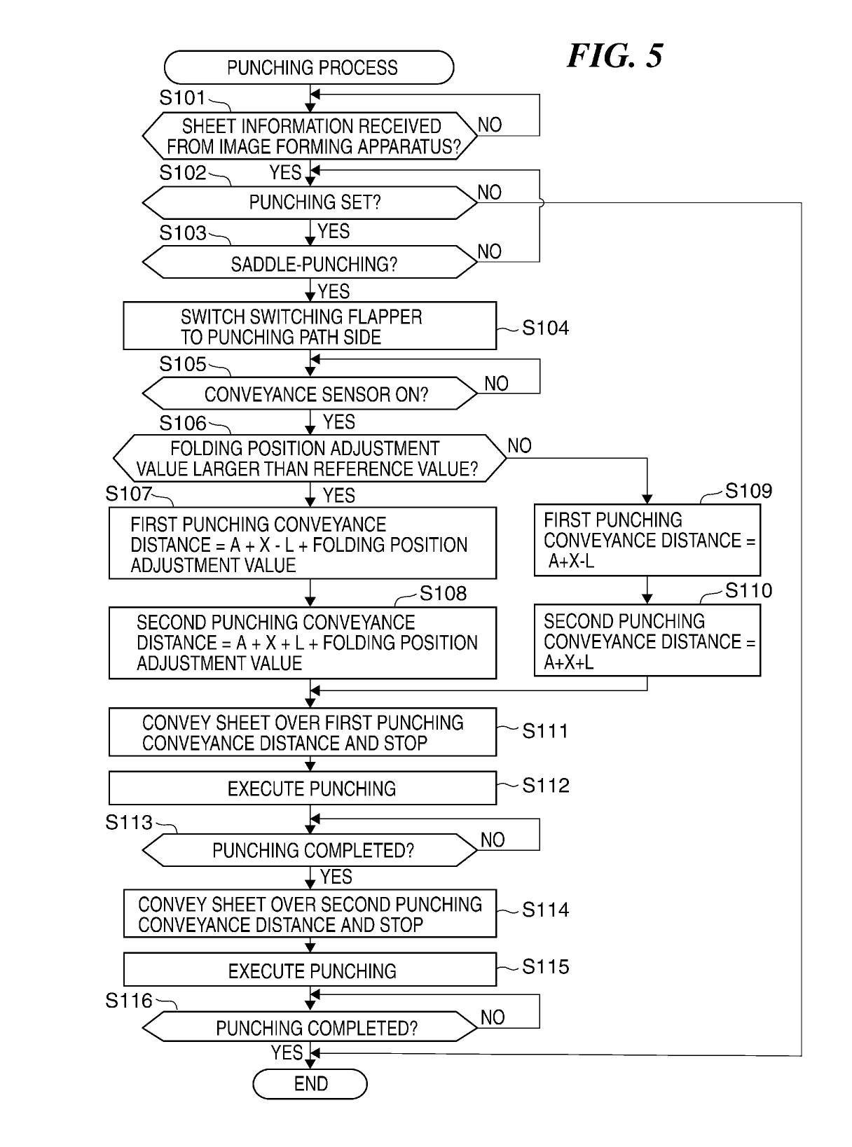

FIG. 5 is a flowchart of the punching process performed.

Referring to FIG. 5, when the punching process is started, first, the CPU 962 determines whether or not sheet information has been received from the image forming apparatus 100 as the upstream apparatus via the communication IC, and waits until the sheet information is received (step S101). The sheet information includes the size of sheets P to be delivered from the image forming apparatus 100 to the puncher 200, a type of punching, and information concerning post-processing.

The CPU 962 determines, based on the received sheet information, whether or not punching has been set (step S102). If it is determined in the step S102 that punching has been set (YES to the step S102), the CPU 962 determines a type of the punching. More specifically, the CPU 962 determines whether or not the punching has been set to saddle-punching by a user (step S103). Saddle-punching is punching performed in the course of producing a sheet bundle for bookbinding by performing center-folding in which sheets are folded in two, so as to punch holes at opposite locations symmetrical with respect to the folding position, and is set by the user via the console 600. The method of setting the saddle-punching will be described in detail hereinafter.

If it is determined in the step S103 that the punching has been set to saddle-punching (YES to the step S103), the CPU 962 proceeds to a step S104, wherein the CPU 962 drives the solenoid SL3 to switch the switching flapper 220 such that the sheet P is conveyed into the punching path 216 (step S104). After having conveyed the sheet P into the punching path 216, the CPU 962 determines, based on a result of detection by the conveyance sensor 212, whether or not the sheet P has reached the conveyance sensor 212, and waits until the sheet P reaches the conveyance sensor 212 (step S105). After the sheet P has reached the conveyance sensor 212, the CPU 962 refers to a folding position adjustment value set in the sheet information received in the step S101, and determines whether or not the folding position adjustment value (strictly, the absolute value thereof) is larger than a reference value (step S106).

The folding position adjustment value is usually a value for correcting a deviation of the folding position, which is caused e.g. by a mechanical error, from a position corresponding to half the length of a sheet P in the sheet conveying direction, which is set as the center-folding position. However, a range of values for correcting the deviation of the folding position, as values of an adjustment width, has a limited span, and the absolute value of the range is determined as the reference value.

In the present embodiment, the reference value of the folding position adjustment width is set e.g. to 2.0 mm, and when the folding position adjustment value is set to a value larger than the reference value, the CPU 962 determines that the user has set shifted-folding in which the folding position is intentionally shifted from the center of a sheet P. The folding position adjustment value is manually set so as to correct a center-folding position error such that the center-folding position becomes within a range limited by the reference value, whereas shifted-folding is center-folding performed by setting the center-folding position, as a target, to a position that does not correspond to half the sheet length (center thereof), without taking the center-folding position error into consideration. Note that the reference value is not limited to 2.0 mm.

Now, a description will be given of a method of setting a center-folding position in the bookbinding process. Setting of bookbinding conditions including setting of the center-folding position is performed by the user via the console 600.

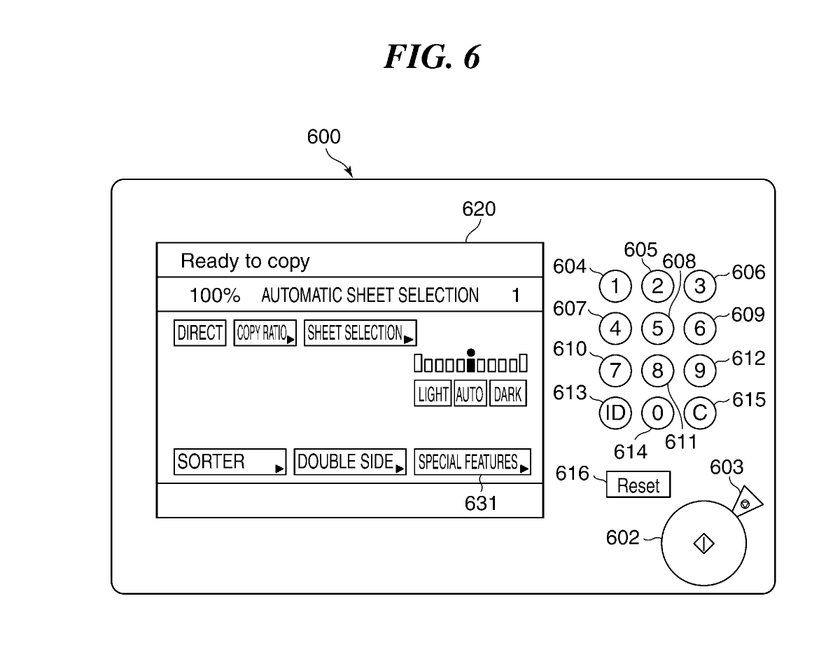

FIG. 6 is a view of the console 600.

Referring to FIG. 6, the console 600 is provided with a start key 602 for starting an image forming operation, a stop key 603 for stopping the image forming operation, and ten keys 604 to 612 and 614 for entering numbers. Further, on the console 600, there are arranged an ID key 613, a clear key 615, a reset key 616, and a user mode key, not shown, for configuring settings for various devices. Furthermore, the console 600 is provided with a display section 620 implemented by a touch panel, and on a display screen of the display section 620, there are displayed various soft keys.

In the following, a description will be given of the method of setting the folding position adjustment value as a specific bookbinding condition, using the console 600.

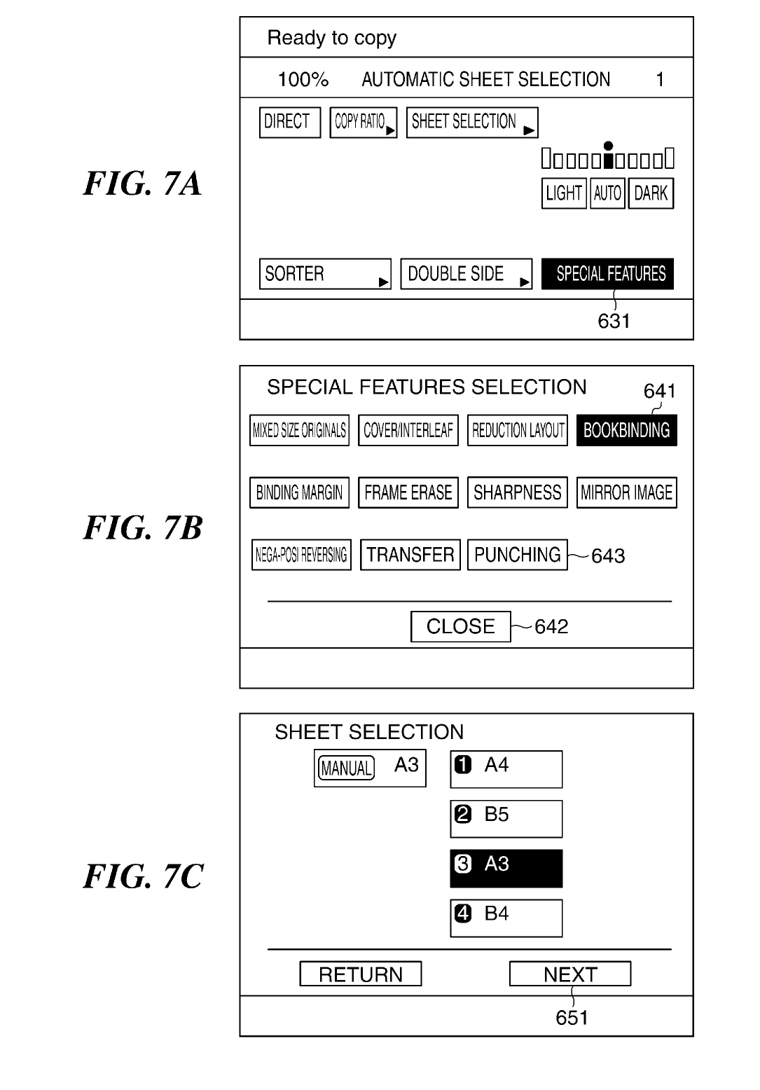

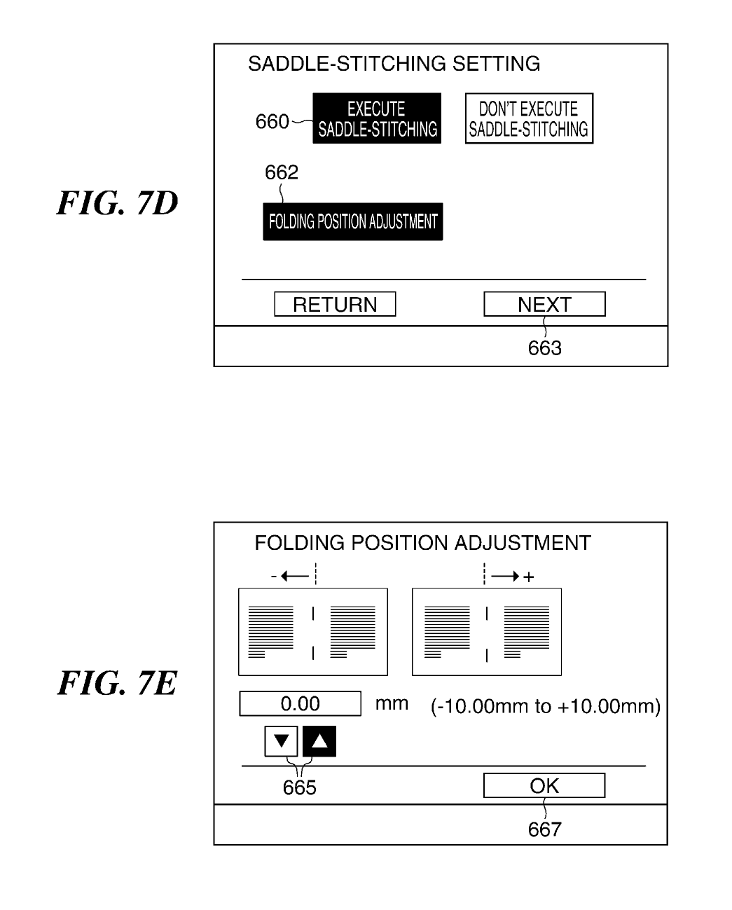

FIGS. 7A to 7E are views illustrating screens displayed on the console 600, for setting the folding position adjustment value.

Referring to FIGS. 7A to 7E, FIG. 7A shows an initial screen displayed on the console 600. When a “special features” key 631 is selected by the user on the initial screen in FIG. 7A, the display section 620 is switched to a special features selection screen (FIG. 7B) for selecting various modes.

When a “bookbinding” key 641 is selected and then a “close” key 642 is pressed by the user on the special features selection screen in FIG. 7B, the display section 620 is switched to a sheet selection screen (FIG. 7C) for selecting a cassette containing recording sheets to be output.

When a cassette containing sheets of a desired size, e.g. an A3 cassette is selected and then a “next” key 651 is pressed by the user on the sheet selection screen in FIG. 7C, the display section 620 is switched to a saddle-stitching setting screen (FIG. 7D). The saddle-stitching setting screen is a screen for setting whether or not to perform saddle stitching on a sheet bundle for bookbinding.

When the bookbinding mode is selected on the special features selection screen in FIG. 7B, at least folding is performed, but whether or not to perform saddle stitching is determined by user selection. More specifically, when an “execute saddle stitching” key 660 is selected and then a “folding position adjustment” key 662 and a “next” key 663 are pressed by the user on the saddle-stitching setting screen in FIG. 7D, the display section 620 is switched to a folding position adjustment screen (FIG. 7E).

The user can set a folding position adjustment value for the sheet bundle to be saddle-stitched, on the folding position adjustment screen in FIG. 7E.

Specifically, on the folding position adjustment screen in FIG. 7E, the user performs selection of a direction, leftward or rightward, in which the folding position is to be shifted with respect to the center of a sheet bundle in an unfolded state thereof, and setting of a folding position adjustment value indicating a shift amount (adjustment amount). The selection of the direction in which the folding position is to be shifted for adjustment and the setting of the folding position adjustment value are performed by operating an up-down key 665. By operating the adjusting the up-down key 665, a value displayed on the screen is changed. In the present embodiment, the folding position adjustment value that can be entered is in a range of −10.00 mm to +10.00 mm, but it may be set to another value the absolute value of which is larger than the reference value. Then, when an “OK” key 667 is pressed by the user, the setting of the bookbinding conditions is completed, and the display section 620 returns to the initial screen (FIG. 7A). Then, the image forming system 1000 waits until the start key 602 is pressed.

Now, a detailed description will be given of the method of setting the punching mode to saddle-punching.

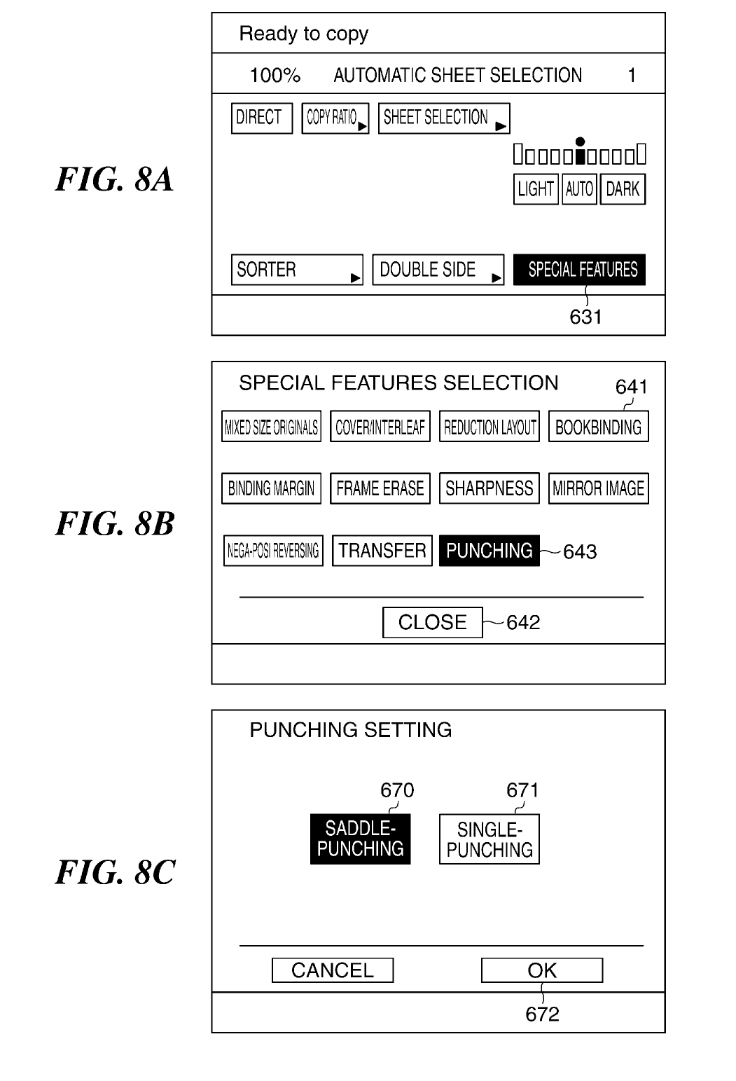

FIGS. 8A to 8C are views illustrating screens displayed on the console 600 for setting the punching mode to saddle-punching.

Referring to FIGS. 8A to 8C, FIG. 8A shows the initial screen displayed on the console 600. When the “special features” key 631 is selected by the user on the initial screen in FIG. 8A, the display section 620 is switched to the special features selection screen (FIG. 8B) for selecting various modes. When the user selects a “punch” key 643 and then presses the “close” key 642 on the special features selection screen in FIG. 8B, the display section 620 is switched to a punching configuration screen (FIG. 8C).

When the user selects either a “saddle-punching” key 670 or a “single-punching” key 671 (the “saddle-punching” key 670 in the illustrated example), and presses an “OK” key 672, setting is completed, and the display section 620 returns to the initial screen (FIG. 8A). Then, the image forming system 1000 enters a standby state and waits until the start key 602 is pressed.

Saddle-punching is processing for punching holes in each sheet at left and right locations symmetrical with respect to the center-folding position at which the sheet is to be center-folded is performed and then bookbinding involving folding is performed on a sheet bundle of the sheets, as described hereinbefore. Single-punching is processing for punching holes in the trailing end of a sheet in the sheet conveying direction.

Referring again to FIG. 5, if it is determined in the step S106 that the folding position adjustment value (strictly, the absolute value thereof) set by the user is larger than the reference value (YES to the step S106), the CPU 962 sets a first punching conveyance distance to a value of A+X−L+folding position adjustment value (step S107). The first punching conveyance distance is a sheet conveying distance over which the sheet P is conveyed, in the case of punching first holes in a sheet P, to a punching position after the conveyance sensor 212 detects the leading edge of the sheet P in the sheet conveying direction. The symbols A, X, and L will be explained hereinafter.

After setting of the first punching conveyance distance is completed (step S107), the CPU 962 sets a second punching conveyance distance to a value of A+X+L+folding position adjustment value (step S108). The second punching conveyance distance is a sheet conveying distance over which the sheet P is conveyed, in the case of punching second holes in the sheet P, to the punching position after the conveyance sensor 212 detects the leading edge of the sheet P in the sheet conveying direction. The symbols A, X, and L will be referred to hereinafter.

On the other hand, if it is determined in the step S106 that the folding position adjustment value (strictly, the absolute value thereof) is not larger than the reference value (NO to the step S106), the CPU 962 sets the first punching conveyance distance to a value of A+X−L (step S109). This means that the entered folding position adjustment value is not reflected in the position of the hole to be punched. Then, the CPU 962 sets the second punching conveyance distance to a value of A+X+L (step S110). The symbols A, X, and L will be referred to hereinafter.

After setting of the first punching conveyance distance and the second punching conveyance distance is completed (steps S107 to S110), the CPU 962 proceeds to a step S111, wherein the CPU 962 controls the punching conveyance motor M23 to convey the sheet P from the conveyance sensor 212 over the first punching conveyance distance, with respect to the leading edge of the sheet P, and stop the conveyance (step S111). Then, the CPU 962 controls the punching motor M25 to execute first punching (step S112).

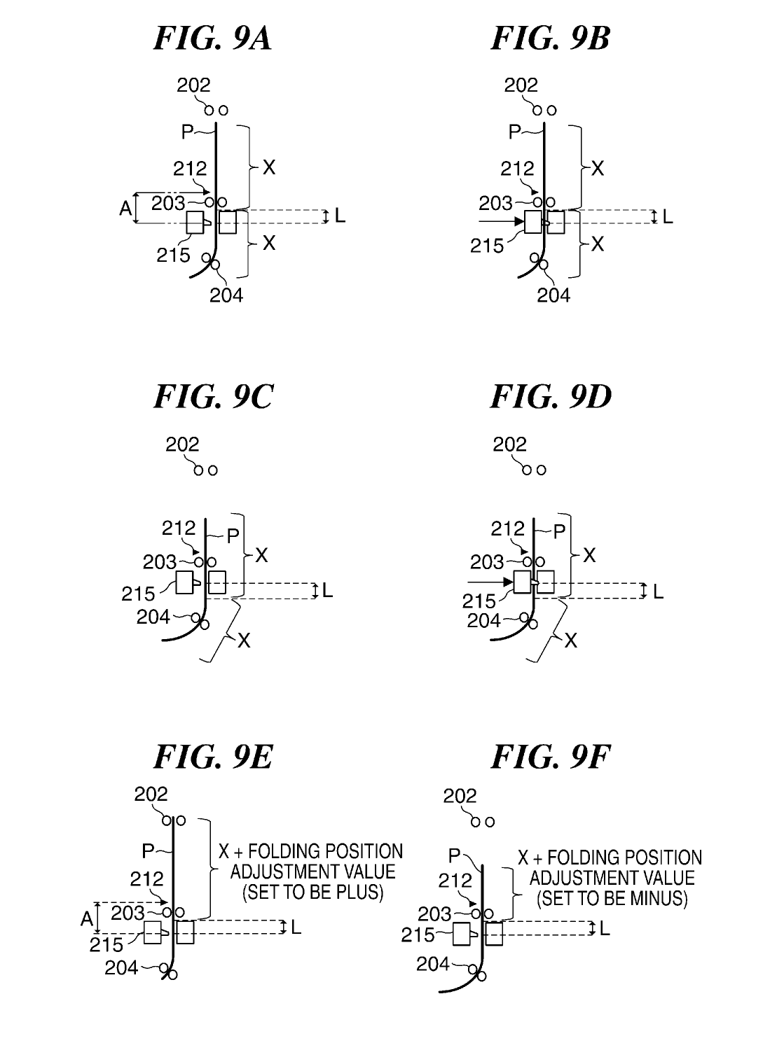

In the following, first, a detailed description will be given, with reference to FIGS. 9A to 9F, of punching performed when the folding position adjustment value is not larger than the reference value (steps S106, S109, S110, S111, S112, and subsequent related steps).

FIGS. 9A to 9F are views useful in explaining the punching conveyance distances and the punching.

Referring to FIGS. 9A to 9F, the symbol A represents a distance from the conveyance sensor 212 disposed upstream of the punching unit 215 to the punching section of the punching unit 215, and the symbol X represents the length corresponding to half the sheet length of the sheet P in the sheet conveying direction. Further, the symbol L represents a length corresponding to a punching margin (offset value for punched holes). A punching margin is a length from a folding position to the center of a punched hole, and is set e.g. to 10 mm.

As described hereinabove, in the case where it is determined in the step S106 that the folding position adjustment value is not larger than the reference value, the CPU 962 sets the first punching conveyance distance to a value of A+X−L (step S109), and the second punching conveyance distance to A+X+L (step S110). Then, the CPU 962 controls the punching conveyance motor M23 to convey the sheet P over the first punching conveyance distance (A+X−L).

FIG. 9A shows a sheet P conveyed from the conveyance sensor 212 over the first punching conveyance distance (A+X−L). In FIG. 9A, the sheet P is in the punching position to which the sheet P is conveyed from the conveyance sensor 212, after the leading edge of the sheet P reaches the conveyance sensor 212, over the first punching conveyance distance (A+X−L) obtained by subtracting the punching margin L from the sum of the distance A from the conveyance sensor 212 to the punching position of the punching unit 215 and the length X corresponding to half the sheet length. The position shown in FIG. 9A, to which the sheet P is conveyed, is a first punching position, and when the sheet P is in this position, the CPU 962 controls the punching motor M25 to execute punching (see FIG. 9B) (step S112).

Then, the CPU 962 determines whether or not the punching has been completed, and waits until the punching is completed (step S113). After completion of the punching, the CPU 962 controls the punching conveyance motor M23 to convey the sheet P, further over a distance of 2L, such that the distance from the second sensor 212 to the leading edge of the sheet P becomes equal to the second punching conveyance distance (A+X+L), and stop the sheet P (step S114) (see FIG. 9C). That is, in FIG. 9C, the sheet P is at rest in a position where the sheet P has been conveyed from the conveyance sensor 212 over the second punching conveyance distance A+X+L. The position shown in FIG. 9C, to which the sheet P is conveyed, is a second punching position, and when the sheet P is in this position, the CPU 962 controls the punching motor M25 to execute punching (see FIG. 9D) (step S115).

Next, a detailed description will be given of punching performed in the case where it is determined in the step S106 that the folding position adjustment value as a tolerance of adjustment width of the folding position is larger than the reference value (steps S106, S107, S108, S111, S112, and subsequent related steps).

If the folding position adjustment value is larger than the reference value (YES to the step S106), the CPU 962 sets the first punching conveyance distance to a value of A+X−L+folding position adjustment value, and the second punching conveyance distance to a value of A+X+L+folding position adjustment value (steps S107 and S108).

FIG. 9E shows a sheet P conveyed over the first punching conveyance distance from the position corresponding to the conveyance sensor 212 in a case where a plus folding position adjustment value the absolute value of which is larger than the reference value is set, i.e. in a case where the folding position is set to a position shifted downstream in the sheet conveying direction. On the other hand, FIG. 9F shows a sheet P conveyed over the first punching conveyance distance from the position corresponding to the conveyance sensor 212 in a case where a minus folding position adjustment value the absolute value of which is larger than the reference value is set, i.e. in a case where the folding position is set to a position shifted upstream in the sheet conveying direction. Note that the second punching position of the sheet P corresponding to the second punching conveyance distance in this case is symmetrical to the first punching position corresponding to the first punching conveyance distance mentioned above, with respect to the folding position.

After the first punching conveyance distance and the second punching conveyance distance are set, the CPU 962 controls the punching conveyance motor M23 and the punching motor M25 to convey the sheet P to the first punching position and execute the first punching (step S112). After completion of the first punching, the CPU 962 controls the punching conveyance motor M23 and the punching motor M25 to convey the sheet P to the second punching position and execute the second punching (step S115).

After thus performing proper punching depending on whether or not the folding position adjustment value (strictly, the absolute value thereof) is larger than the reference value (steps S106 to S115), the CPU 962 determines whether or not the punching has been completed, and waits until the punching is completed (step S116). After completion of the punching, the CPU 962 controls the sheet discharge motor M24 to discharge the sheet P having undergone the punching into the finisher 500 as the downstream apparatus, followed by terminating the present process.

On the other hand, if it is determined in the step S102 that punching has not been designated (NO to the step S102), the CPU 962 discharges the sheet P into the finisher 500 without executing punching. Further, if it is determined in the step S103 that the punching set by the user is not saddle-punching, the CPU 962 returns to the step S102.

According to the punching process in FIG. 5, when the folding position adjustment value set by the user is larger than the reference value, holes are punched in a sheet at locations symmetrical with respect to a folding position on which the reference value is reflected (steps S112 and S115). This causes punched holes to be formed in each sheet with reference to a shifted folding position, and by folding the sheets at the shifted folding position for bookbinding, it is possible to produce a brochure having the punched holes at identical positions between the front and back sides thereof.

Next, a description will be given of a sheet bundle-forming process that is performed using sheets P subjected to punching.

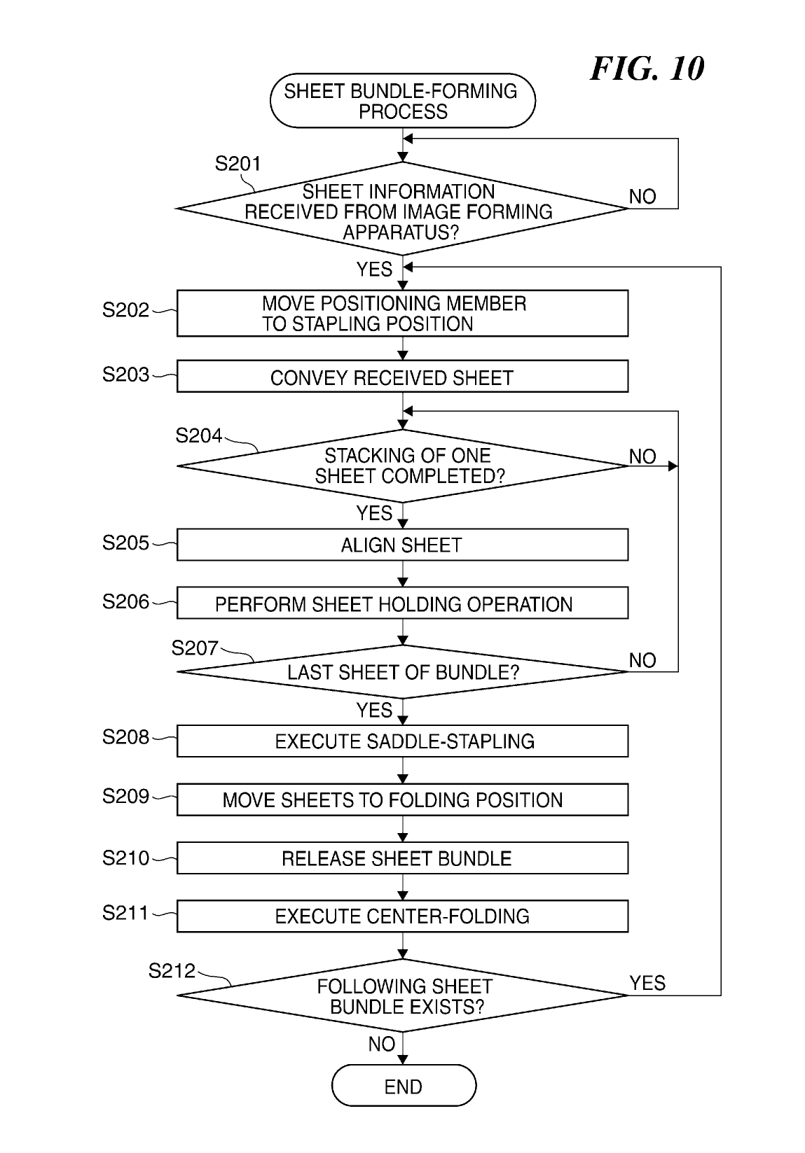

FIG. 10 is a flowchart of the sheet bundle-forming process performed by the image forming system in FIG. 1. The sheet bundle-forming process is performed by taking into account a folding position adjustment value set by the user via the console 600 (setting unit), and the CPU 952 of the finisher 500 executes this process according to a sheet bundle-forming process program stored in the ROM 953.

Referring to FIG. 10, when the sheet bundle-forming process is started, first, the CPU 952 determines whether or not sheet information sent from the image forming apparatus 100 via the communication IC has been received, and waits until the sheet information is received (step S201). The sheet information contains the size of sheets P to be received by the finisher 500 and information concerning post-processing such as a type of post-processing.

After receipt of the sheet information from the image forming apparatus 100, the CPU 952 controls the positioning motor M11 to move the positioning member 805 of the bookbinding tray 580 of the finisher 500 to the stapling position (step S202). The stapling position of the positioning member 805 corresponds to a position of the positioning member 805 where after the trailing edge of a sheet P in the sheet conveying direction passes through the conveying roller pair 801, the center of the sheet length of the sheet P positioned by the positioning member 805 is aligned with the stapling position of the saddle-stitching stapler 820a. The stapling position of the positioning member 805 is changed according to the size of a sheet P. Note that the length of a sheet P in the sheet conveying direction is represented by 2Y, and half the sheet length, represented by Y, will be referred to hereafter as the reference distance.

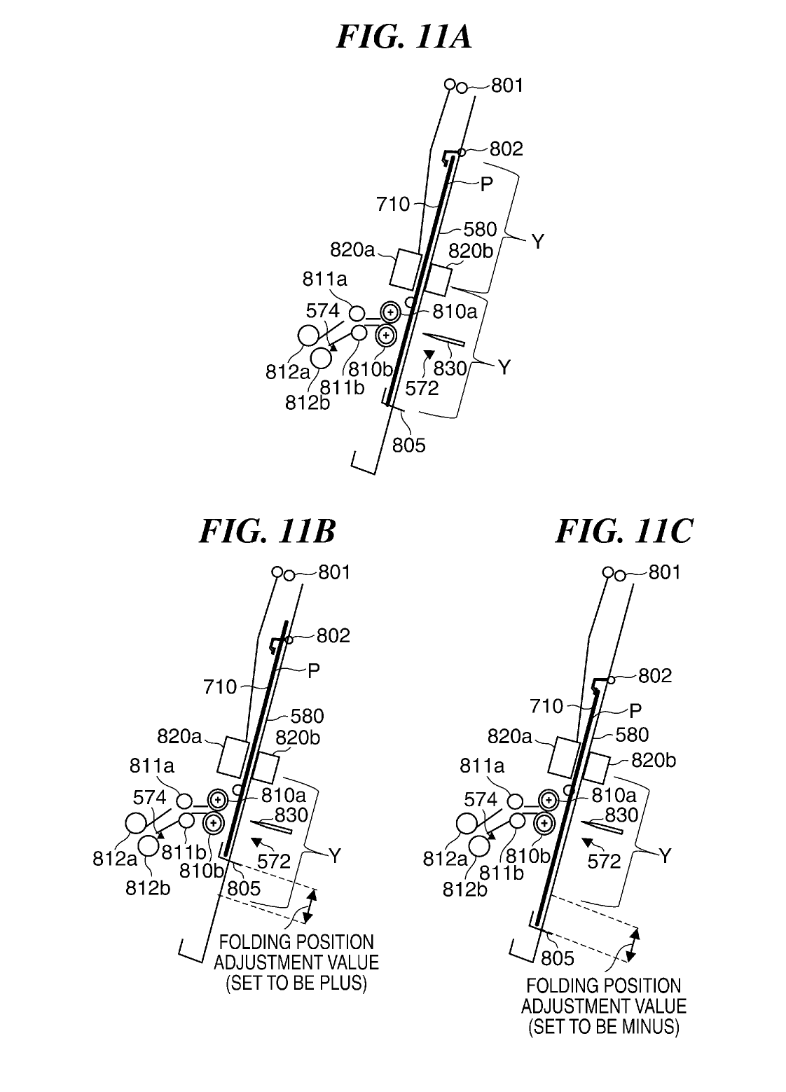

FIGS. 11A to 11C are views useful in explaining the stapling position of the positioning member 805 on the brochure tray 703.

Referring to FIG. 11A, the distance (Y) corresponding to a distance from the positioning member 805 to the stapling position of the saddle-stitching stapler 820a, i.e. ½ of the sheet length (2Y) of a sheet P indicated by a bold line in FIG. 11A is the reference distance. By thus defining the reference distance (Y), when a saddle-stitched sheet bundle for bookbinding is made by folding sheets P subjected to stapling in two, staples are aligned with the center-folding position.

However, when the sheet information received in the step S201 includes a setting of the folding position adjustment value, the positioning member 805 is offset by an amount corresponding to the folding position adjustment value. Specifically, when the folding position adjustment value has been set to a plus value, the positioning member 805 is offset upward with respect to the reference distance Y by an amount corresponding to the folding position adjustment value, as shown in FIG. 11B. On the other hand, when the folding position adjustment value has been set to a minus value, the positioning member 805 is offset downward with respect to the reference distance Y by an amount corresponding to the folding position adjustment value, as shown in FIG. 11C.

Referring again to FIG. 10, after having moved the positioning member 805 to the stapling position (step S202), the CPU 952 receives a sheet P from the puncher 200 as the upstream apparatus and starts conveyance of the sheet P toward the bookbinding tray 580 (step S203). More specifically, the CPU 952 controls the inlet motor M1 and the conveyance motor M8 to cause rotation of the inlet roller pair 511 and the conveying roller pairs 502, 503, 515, 543, and 801.

This causes the sheet P discharged from the puncher 200 to be taken into the finisher 500 and be conveyed to the bookbinding tray 580. In doing this, the switching flapper 514 is held by a solenoid, not shown, in a state for guiding the sheet P into the bookbinding path 523.

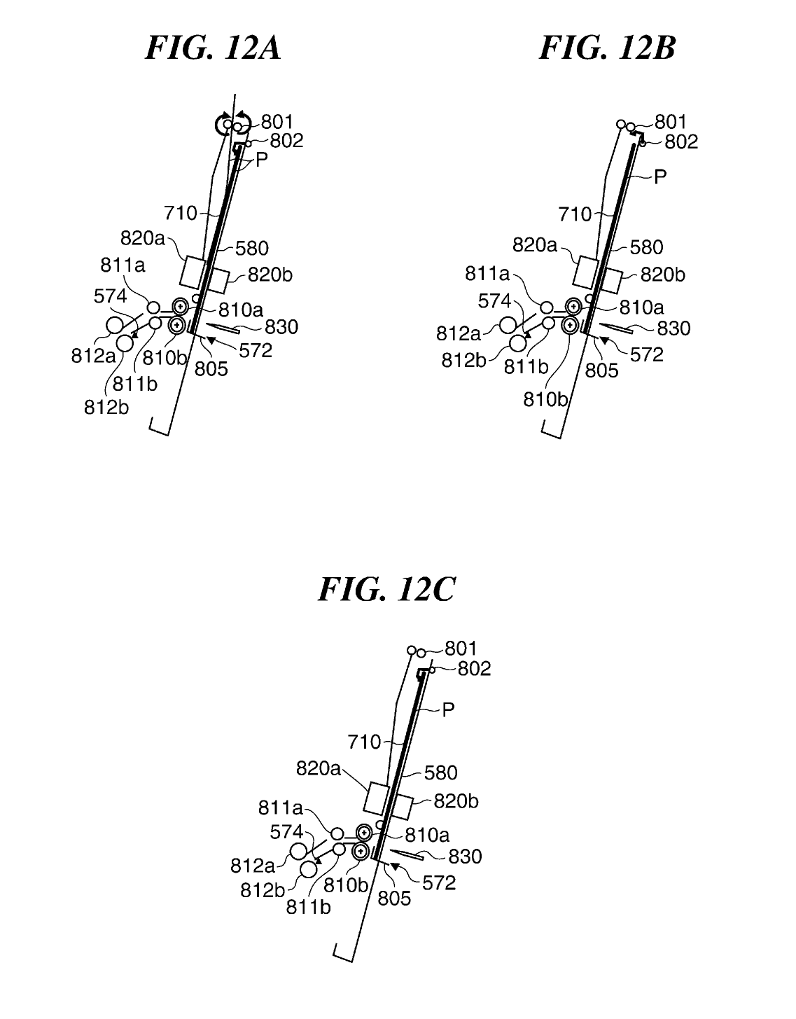

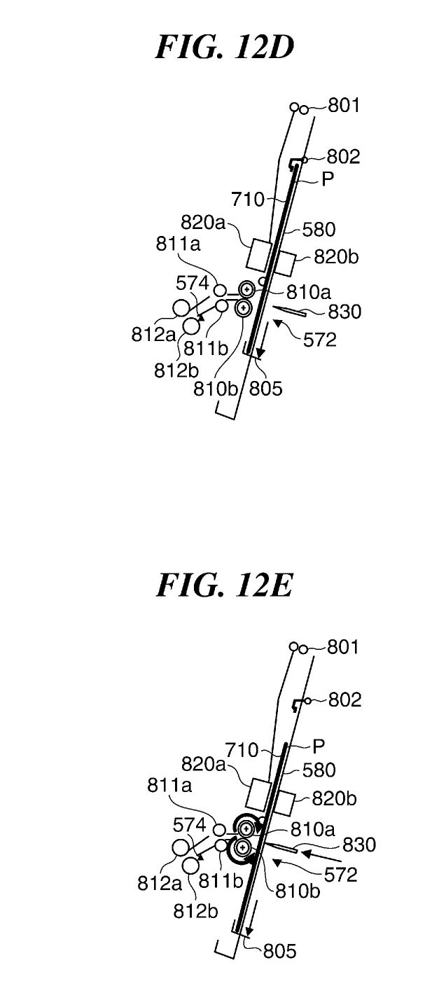

FIGS. 12A to 12E are views illustrating a procedure of center-folding performed on the bookbinding tray 580. In the following, the sheet bundle-forming process will continue to be described with reference to FIGS. 12A to 12E.

Referring to FIGS. 12A to 12E, the sheet P conveyed onto the bookbinding tray 580 and having reached the stapling position is at rest with its leading edge held in abutment with the positioning member 805 (FIG. 12A). After having conveyed the sheet P to the bookbinding tray 580, the CPU 952 determines whether or not stacking operation for the sheet P has been completed, and waits until the operation is completed (step S204).

After completion of the stacking operation for the sheet P, the CPU 952 controls the alignment member, not shown, provided on the bookbinding tray 580 to move the alignment member in a direction orthogonal to the sheet conveying direction, thereby aligning the sheet P in the direction orthogonal to the sheet conveying direction (step S205). After having aligned the sheet P, the CPU 952 causes a holding operation to be performed for holding the sheet P (step S206). More specifically, the CPU 952 causes the sheet holding motor M12 to drive the sheet holding member 802 for temporarily causing the same to perform a releasing operation for releasing sheets P held thereby, so as to receive anew the aligned sheet P thereon (see FIG. 12B).

Then, the CPU 952 causes the sheet holding member 802 to perform a holding operation for holding the sheets P having the new sheet P added thereto again. The CPU 952 repeatedly carries out the holding operation and the releasing operation whenever a sheet P is conveyed (see FIGS. 12B and 12C). In doing this, the sheet holding member 802 repeats operation for holding and releasing the trailing edge of each of the sheets P. This holding operation makes it possible to prevent occurrence of stacking failure, such as jam, due to interference between the trailing edges of precedingly stacked sheets P and the leading edge of a following sheet P conveyed after the precedingly stacked sheets P.

After execution of the sheet holding operation, the CPU 952 determines whether or not the sheet P conveyed to the bookbinding tray 580 is the last sheet of the bundle (step S207). If it is determined in the step S207 that the sheet P is the last sheet of the bundle (YES to the step S207), the CPU 952 proceeds to a step S208.

Specifically, in the step S208, the CPU 952 controls the positioning motor M11 to move the positioning member 805, thereby moving the sheet bundle 710 to the stapling position on which is reflected the folding position adjustment value described with reference to FIGS. 11A to 11C (see FIG. 12D). Thereafter, the CPU 952 controls the saddle-stapling motor M13 to perform saddle-stapling with the saddle-stitching stapler 820a and the anvil 820b, as a stapling operation (step S208).

After completion of the saddle-stapling, the CPU 952 controls the positioning motor M11 and the sheet holding motor M12 to move the positioning member 805 and the sheet holding member 802. More specifically, the CPU 952 causes the positioning member 805 and the sheet holding member 802 to be moved until the stapling position of the sheet bundle matches the folding position (step S209). Then, the CPU 952 causes the sheet holding motor M12 to drive the sheet holding member 802 for performing the releasing operation, thereby terminating the sheet bundle holding operation to release the sheet bundle (step S210) (see FIG. 12E).

Then, the CPU 952 causes the folding motor M9 to drive the folding rollers 810a and 810b for rotation, and at the same time cause the thrusting motor M10 to drive the thrusting member 830 for thrusting toward the folding rollers 810a and 810b, thereby executing center-folding of the sheet bundle (step S211). The sheet bundle thrust toward the folding rollers 810a and 810b is conveyed downstream while being folded by the folding rollers 810a and 810b, followed by being discharged onto the brochure tray 703 by the folding conveying rollers 811a and 811b and the folding discharge rollers 812a and 812b.

Then, the CPU 952 determines whether or not there is a following bundle (step S212). If there is no following bundle (NO to the step S212), the CPU 952 terminates the present process.

On the other hand, if there is a following bundle (YES to the step S212), the CPU 952 returns to the step S202, and continues the sheet bundle-forming process. Further, if it is determined in the step S207 that the sheet P is not the last sheet of the bundle (NO to the step S207), the CPU 952 returns to the step S204, and waits until a stacking operation for the following sheet is completed.

According to the FIG. 10 process, the positioning member 805 on which sheets P are to be stacked is moved such that the center-folding position set for the sheets P by the user is aligned with the stapling position of the saddle-stitching stapler 820a (step S202). Thereafter, the sheets P are stacked on the positioning member 805 to form a sheet bundle, and the sheet bundle is saddle-stitched by the saddle-stitching stapler 820a at the center-folding position (step S208) and then bookbound by being folded in two with respect to the center-folding position (step S211). This makes it possible to produce an excellent brochure having holes punched at locations symmetrical with respect to the folding position and stapling position on which the folding position adjustment value set by the user is reflected.

Further, according to the present embodiment, even when the folding position is changed or adjusted by a user, it is not required to perform any complicated processing, which makes it possible to produce a brochure having holes punched at left and right locations symmetrical with respect to the folding position of a sheet bundle without requiring the user to perform any conscious operation.

Next, a description will be given of a second punching process performed as a part of the bookbinding process by the image forming system 1000 shown in FIG. 1.

The second punching process is performed by taking into account a shifted-folding position adjustment value, referred to hereinafter, which is set by the user. The second punching process is performed by the CPU 962 of the puncher 200 according to a second punching process program stored in the ROM 963. The following description will be given focusing on different points between the second punching process and the punching process in FIG. 5.

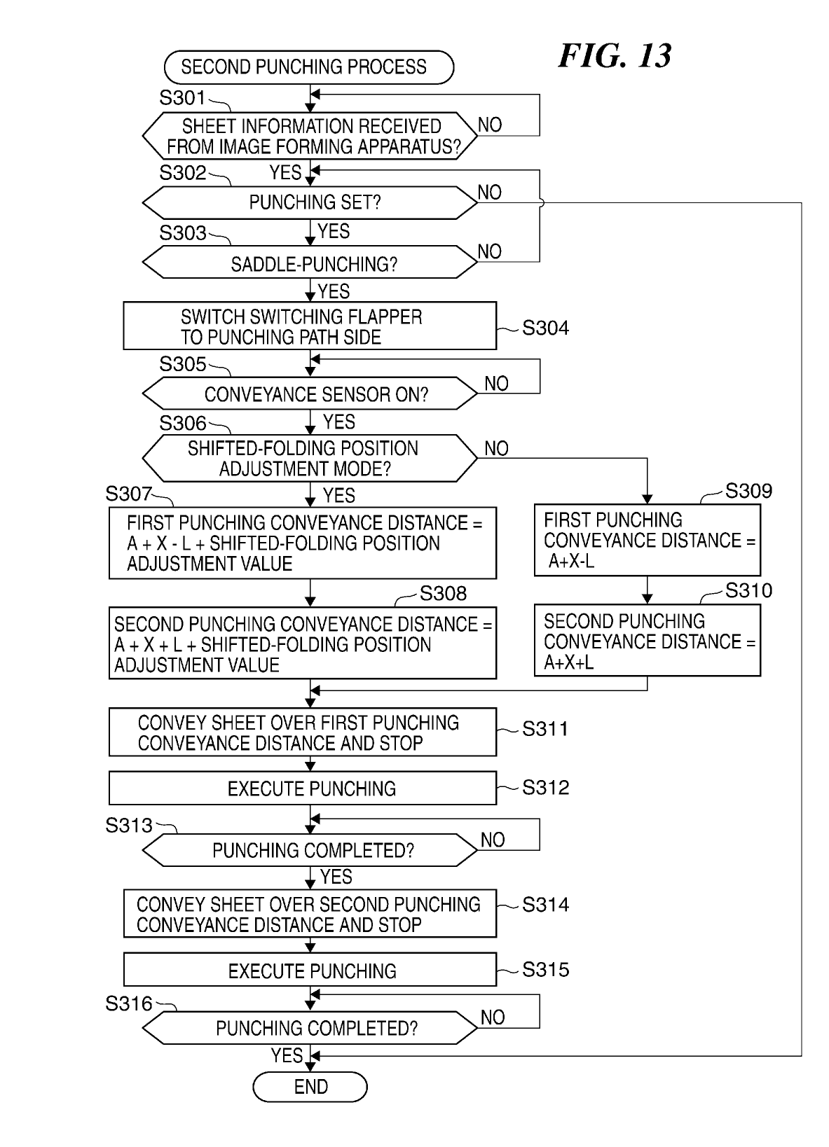

FIG. 13 is a flowchart of the second punching process performed by the image forming system shown in FIG. 1.

Steps S301 to S305 in FIG. 13 are the same as the steps S101 to S105 in FIG. 5, and therefore description thereof is omitted.

If it is determined in the step S305 that a sheet P has reached the conveyance sensor 212 (YES to the step S305), the CPU 962 proceeds to a step S306, wherein the CPU 962 refers to a setting of a center-folding mode included in the sheet information received in the step S301 and determines whether or not the center-folding mode is set to a shifted-folding position adjustment mode (step S306).

The shifted-folding position adjustment mode is a mode in which when a user sets a folding position of a sheet P such that the folding position is intentionally shifted from the center of the sheet length of the sheet P in the sheet conveying direction, holes are punched in the sheet P at locations on which is reflected a shifted-folding position adjustment value set by the user.

In the following, a description will be given of a method of setting the shifted-folding position adjustment value in the shifted-folding position adjustment mode. The shifted-folding position adjustment value is set by the user via the console 600.

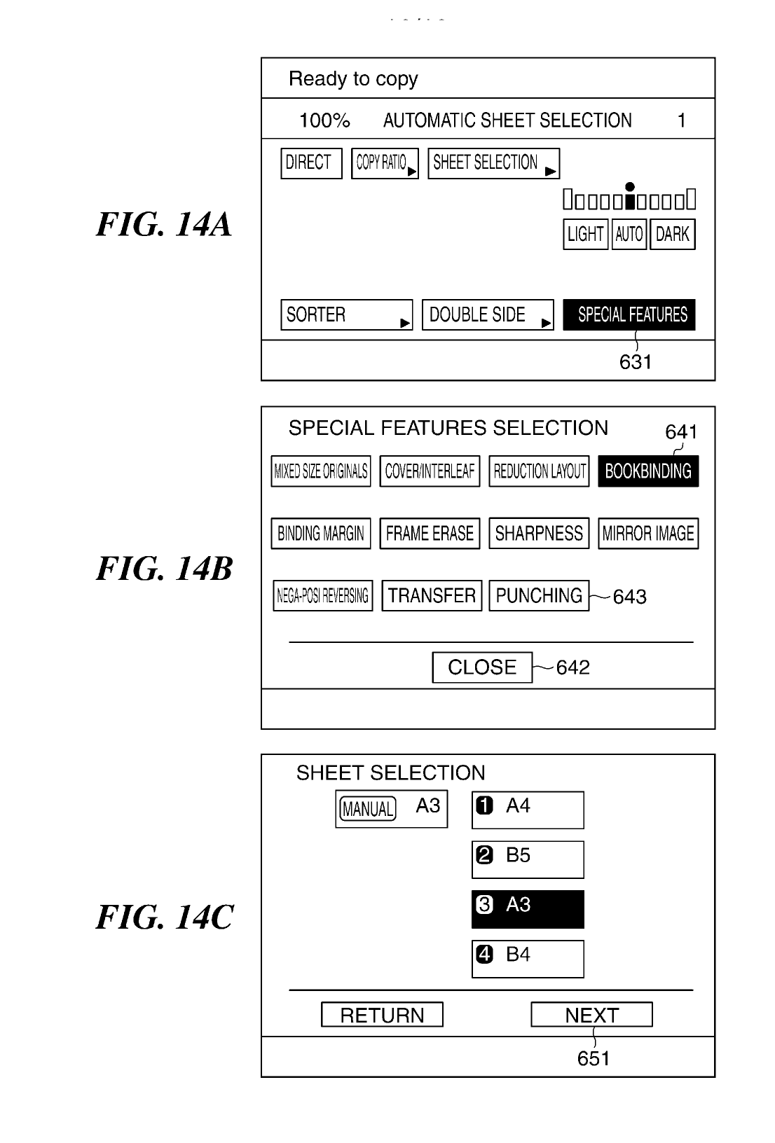

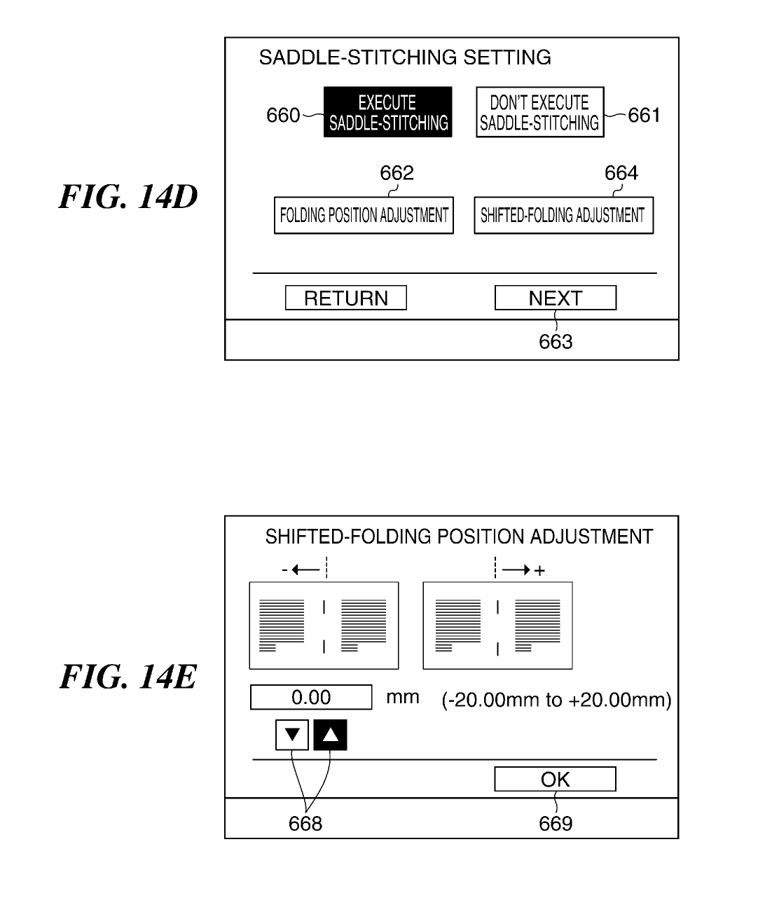

FIGS. 14A to 14E are views illustrating screens, which are displayed on the console 600, for setting of the shifted-folding position adjustment value.

Referring to FIGS. 14A to 14E, FIG. 14A is the initial screen displayed on the console 600. When the “special features” key 631 is selected by the user on the initial screen in FIG. 14A, the display section 620 is switched to the special features selection screen (FIG. 14B) for selecting various modes.

When the “bookbinding” key 641 is selected and then the “close” key 642 is pressed by the user on the special features selection screen in FIG. 14B, the display section 620 is switched to the sheet selection screen (FIG. 14C) for selecting a cassette.

When e.g. the A3 cassette is selected and then the “next” key 651 is pressed by the user on the sheet selection screen in FIG. 14C, the display section 620 is switched to the saddle-stitching setting screen (FIG. 14D). When either the “execute saddle stitching” key 660 or a “don't execute saddle stitching” key 661 is pressed and then a “shifted-folding adjustment” key 664 is pressed by the user on the saddle-stitching setting screen in FIG. 14D, the display section 620 is switched to a shifted-folding position adjustment screen (FIG. 14E).

On the shifted-folding position adjustment screen (FIG. 14E), the user performs configuration for shifting a center-folding position on a sheet bundle for center-folding bookbinding. A mode for shifting the center-folding position in a predetermined direction from the center of the sheet length is referred to as the shifted-folding position adjustment mode.

On the shifted-folding position adjustment screen shown in FIG. 14E, the user performs selection of a direction, leftward or rightward, in which the folding position is to be shifted with respect to the center of a sheet bundle in an unfolded state thereof, and setting of a shifted-folding position adjustment value indicating a shift amount. The selection of the direction, leftward or rightward, in which the folding position is to be shifted and the setting of the shifted-folding position adjustment value are performed by operating an up-down key 668. By operating the up-down key 668, a value displayed on the screen is changed. Thereafter, when an “OK” key 669 is pressed by the user, the setting of the bookbinding conditions is completed, and the display section 620 returns to the initial screen (FIG. 14A). The image forming system 1000 is held in a standby state until the start key 602 is pressed and an operation is started.

Note that in a case where the “folding position adjustment” key 662 is pressed by the user on the saddle-stitching setting screen in FIG. 14D after setting the shifted-folding position adjustment value, the display section 620 is switched to the folding position adjustment screen shown in FIG. 7E. In the present embodiment, it is possible to set the folding position adjustment value and the shifted-folding position adjustment value by sequentially pressing the “folding position adjustment” key 662 and the “shifted-folding adjustment” key 664. This makes it possible to set the shift amount by which the center-folding position is shifted from the center of the sheet length in the sheet conveying direction and an error margin of the shifted center-folding position.

Referring again to FIG. 13, if it is determined in the step S306 that the center-folding mode has been set to the shifted-folding position adjustment mode (YES to the step S306), the CPU 962 proceeds to a step S307, wherein the CPU 962 sets the first punching conveyance distance to a value of A+X−L+shifted-folding position adjustment value (step S307). The symbols A, X, and L are the same as defined with reference to FIG. 5. After completion of the setting of the first punching conveyance distance (step S307), the CPU 962 sets the second punching conveyance distance to a value of A+X+L+shifted-folding position adjustment value (step S308).

On the other hand, if it is determined in the step S306 that the center-folding mode has not been set to the shifted-folding position adjustment mode (NO to the step S306), the CPU 962 proceeds to a step S309, wherein the CPU 962 sets the first punching conveyance distance to a value of A+X−L (step S309). Then the CPU 962 sets the second punching conveyance distance to a value of A+X+L (step S310).

Steps S311 to S316 are the same as the steps S111 to S116 in FIG. 5, and therefore description thereof is omitted.

According to the punching process in FIG. 13, when a shifted-folding position adjustment value is set by the user, punching positions are set to respective left and right locations symmetrical with respect to a center-folding position on which is reflected the shifted-folding position adjustment value, and holes are punches in the determined punching position (steps S312 and S315). This makes it possible, even when the user intentionally sets the folding position of sheets P such that the folding position is shifted from the center of the sheet length, to produce a brochure having positions of punched holes eventually aligned between the front and back sides thereof, by folding the sheets P formed with the punched holes in two at the center-folding position, for bookbinding.

Next, a description will be given of a second sheet bundle-forming process performed on sheets P subjected to the second punching process in FIG. 13.

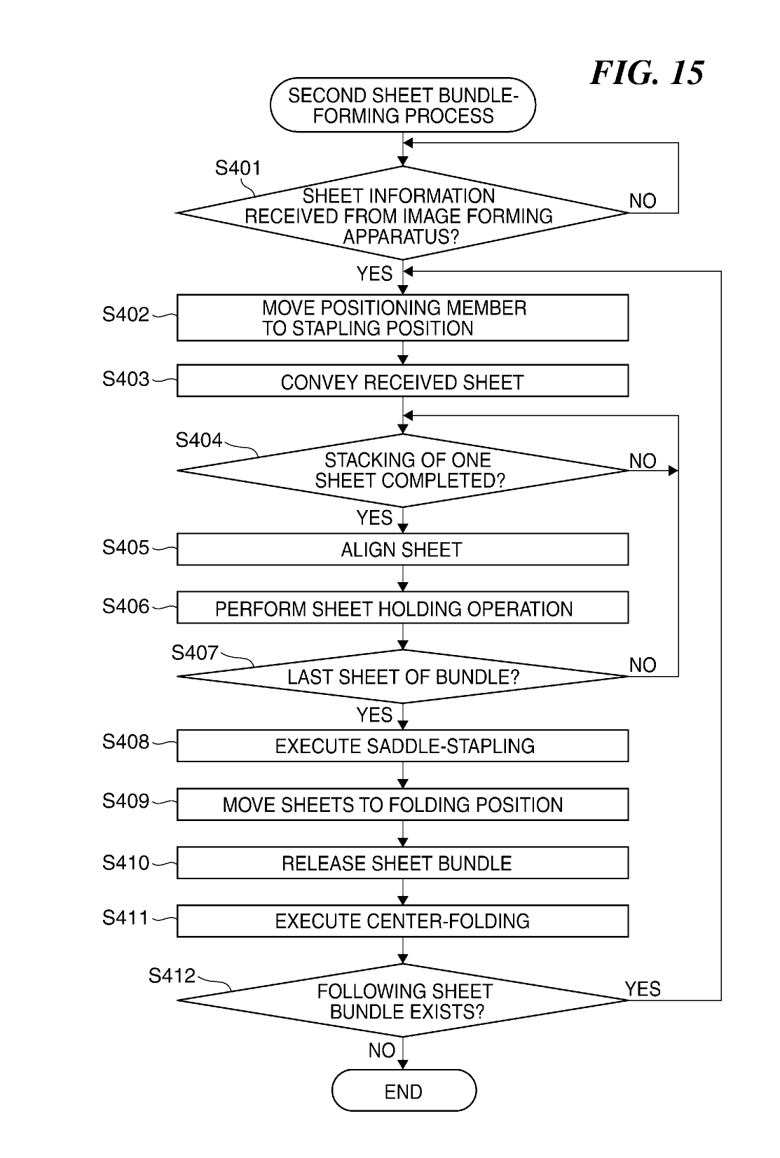

FIG. 15 is a flowchart of the second sheet bundle-forming process performed by the image forming system in FIG. 1. The second sheet bundle-forming process is a bookbinding process performed by taking into account a shifted-folding position adjustment value set by the user via the console 600 (setting unit). This second sheet bundle-forming process is performed by the CPU 952 of the finisher 500 according to a second sheet bundle-forming process program stored in the ROM 953.

Referring to FIG. 15, when the second sheet bundle-forming process is started, first, the CPU 952 determines whether or not sheet information sent from the image forming apparatus 100 via the communication IC has been received, and waits until the sheet information is received (step S401). The sheet information includes the size of sheets P to be delivered to the finisher 500, a type of post-processing, a folding position adjustment value, a shifted-folding position adjustment value, and so forth.

After receipt of the sheet information, the CPU 952 controls the positioning motor M11 to move the positioning member 805 of the bookbinding tray 580 to the stapling position (step S402). The stapling position where stapling is performed on a sheet bundle corresponds to the center-folding position of the sheets P on which are reflected the folding position adjustment value and the shifted-folding position adjustment value set in the FIG. 13 process. Therefore, the CPU 952 moves the positioning member 805 to a position where the center-folding position on which are reflected the folding position adjustment value and the shifted-folding position adjustment value of the sheet bundle to be positioned by the positioning member 805 is aligned with the stapling position of the saddle-stitching stapler 820a.

After having moved the positioning member 805 to the stapling position (step S402), the CPU 952 receives the sheet P from the puncher 200 as the upstream apparatus and starts conveyance of the sheet P toward the bookbinding tray 580 (step S403).

Steps S404 to S412 are the same as the steps S204 to S212 in FIG. 10, and therefore description thereof is omitted.

According to he second sheet bundle-forming process shown in FIG. 15, when a user intentionally configures the settings for shifting the center-folding position, a sheet bundle is formed using sheets P each having holes punched therein at left and right locations symmetrical with respect to a shifted center-folding position set by the user (step S405). Then, stapling processing is performed at the shifted center-folding position of the formed sheet bundle (step S406), and the sheet bundle is bookbound by being folded in two at the center-folding position (step S411). Thus, it is possible to produce an excellent brochure desired by the user, which has holes punched at the locations symmetrical with respect to the shifted folding position and stapling position intentionally set by the user.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-177544 filed Sep. 9, 2015 which is hereby incorporated by reference herein in its entirety.

What is claimed is:

1. An image forming system comprising:
a punching unit configured to punch holes in a sheet;
a folding unit configured to fold a sheet bundle formed by sheets each having the holes punched therein; and
a setting unit configured to set an adjustment value for adjusting a folding position where said folding unit folds the sheet bundle, according to a manual operation,
wherein when the adjustment value set by said setting unit is larger than a reference value, said punching unit determines a punching position with respect to a folding position on which is reflected the adjustment value set by said setting unit, and punches the holes at the determined punching position.

2. The image forming system according to claim 1, wherein when the adjustment value set by said setting unit is not larger than the reference value, said punching unit determines a punching position with respect to a folding position on which is not reflected the adjustment value set by said setting unit, and said folding unit folds the sheet bundle at the folding position on which is not reflected the adjustment value.

3. The image forming system according to claim 1, wherein said punching unit punches the holes in the sheet at opposite locations symmetrical with respect to the folding position on which is reflected the adjustment value.

4. The image forming system according to claim 3, wherein said folding unit folds the sheet bundle at the folding position on which is reflected the adjustment value.

5. The image forming system according to claim 4, further comprising a saddle stitching unit, and
wherein said saddle stitching unit performs saddle-stapling on the sheet bundle at the folding position on which is reflected the adjustment value, and
wherein said folding unit folds the sheet bundle having subjected to the saddle-stapling.

6. The image forming system according to claim 1, further comprising an image forming apparatus, and
wherein the sheet is a sheet having an image formed thereon by said image forming apparatus.

7. The image forming system according to claim 1, further comprising a puncher, and
wherein said punching unit is provided in said puncher.

8. The image forming system according to claim 1, further comprising a sheet processing apparatus, and
wherein said folding unit is provided in said sheet processing apparatus.

9. The image forming system according to claim 5, further comprising a sheet processing apparatus, and
wherein said saddle stitching unit is provided in said sheet processing apparatus.

10. An image forming system comprising:
a punching unit configured to punch holes in a sheet;
a folding unit configured to fold a sheet bundle formed by sheets each having the holes punched therein; and
a setting unit configured to set a shift amount for shifting a folding position from a center of a sheet length of the sheet in a sheet conveying direction, according to a manual operation,
wherein when the shift amount is set by said setting unit, said punching unit determines a punching position with respect to a folding position on which the shift amount is reflected, and punches the holes in the determined punching position.

11. The image forming system according to claim 10, wherein when the shift amount has not been set by said setting unit, said punching unit determines a punching position with respect to a folding position on which is not reflected the shift amount, and said folding unit folds the sheet bundle at the folding position on which is not reflected the shift amount.

12. The image forming system according to claim 10, wherein said punching unit punches the holes in the sheet at opposite locations symmetrical with respect to the folding position on which is reflected the shift amount.

13. The image forming system according to claim 12, wherein said folding unit folds the sheet bundle at the folding position on which is reflected the shift amount.

14. The image forming system according to claim 13, further comprising a saddle stitching unit, and
wherein said saddle stitching unit performs saddle-stapling on the sheet bundle at the folding position on which is reflected the shift amount, and
wherein said folding unit folds the sheet bundle having subjected to the saddle-stapling.

15. The image forming system according to claim 10, further comprising an image forming apparatus, and
wherein the sheet is a sheet having an image formed thereon by said image forming apparatus.

16. The image forming system according to claim 10, further comprising a puncher, and
wherein said punching unit is provided in said puncher.

17. The image forming system according to claim 10, further comprising a sheet processing apparatus, and
wherein said folding unit is provided in said sheet processing apparatus.

18. The image forming system according to claim 14, further comprising a sheet processing apparatus, and
wherein said saddle stitching unit is provided in said sheet processing apparatus.
